(19) United States
(12) Patent Application Publication
(10) Pub. No.: US 2014/0253045 A1
(43) Pub. Date: Sep. 11, 2014

(54) METHOD AND APPARATUS FOR BATTERY CONTROL

(71) Applicant: EnerDel Inc., Greenfield, IN (US)

(72) Inventor: Tomasz Poznar, Wroclaw (PL)

(73) Assignee: EnerDel Inc., Greenfield, IN (US)

(21) Appl. No.: 14/201,855

(22) Filed: Mar. 8, 2014

Related U.S. Application Data
(60) Provisional application No. 61/776,678, filed on Mar. 11, 2013.

(51) Int. Cl. H02J 7/00

(52) U.S. Cl. CPC H02J 7/0063
USPC 320/136

(57) ABSTRACT

Generally, a system and a method for controlling a battery to power a load disable battery discharge if a battery voltage is less than a low voltage. Disabling battery discharge inhibits current flow from the battery to the load. Battery discharge is enabled after receipt of a reserve enable signal even if the battery voltage is less than the low voltage.

### CROSS-REFERENCE TO RELATED APPLICATIONS

This application claims the benefit of U.S. Provisional Application Ser. No. 61/776,678, filed Mar. 11, 2013, titled METHOD AND APPARATUS FOR BATTERY CONTROL, docket ENERD-012-010-01-US-E, the entire disclosure of which is expressly incorporated by reference herein.

### TECHNICAL FIELD

The disclosure relates generally to energy-based systems, and in particular to a method and a system for battery discharge control.

### BACKGROUND OF THE DISCLOSURE

Energy storage technologies include lithium, nickel metal hydride (NiMH), lead acid (PbA) and nickel cadmium (NiCd), and other chemical technologies. Each technology has advantages and disadvantages. For example, lithium batteries are less tolerant of overcharging than other battery technologies. The available capacity (e.g., watt-hours) of lithium batteries varies as a function of the voltage at which charging is stopped. Also, capacity degrades with increasing charge voltages. Charging lithium batteries to lower charge voltages reduces usable capacity.

Batteries may become damaged if discharged beyond a minimum voltage. If the minimum voltage is reached, the batteries should be recharged. Because energy should not be drawn from the batteries after they reach the minimum voltage, to avoid damaging the batteries, there are situations in which the functions of the electrical load on the battery cannot be safely performed.

A need exists for systems and methods for preventing over-discharging the battery without inhibiting load functions.

### SUMMARY OF EMBODIMENTS OF THE DISCLOSURE

Embodiments of a method and an apparatus for controlling a battery are provided. In one embodiment of the method for controlling a battery to power a load, the method comprises measuring a battery voltage; disabling battery discharge if the battery voltage is less than a low voltage, wherein disabling battery discharge inhibits current flow from the battery to the load; receiving a reserve enable signal; and enabling battery discharge after receipt of the reserve enable signal even if the battery voltage is less than the low voltage.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIG. 1 is a timing diagram illustrating a method to control a battery in accordance with an example set forth in the disclosure;

FIG. 2 is a flowchart of a method to control a battery in accordance with an example set forth in the disclosure;

FIG. 3 is a block diagram of an apparatus in accordance with an example set forth in the disclosure;

FIG. 4 is a block diagram of an apparatus in accordance with another example set forth in the disclosure;

FIGS. 5 and 5A are schematic diagrams of a battery and engine arrangement in accordance with another example set forth in the disclosure; and

FIG. 6 is a perspective view of a battery comprising multiple battery cells in accordance with another example set forth in the disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present invention. The exemplification set out herein illustrates embodiments of the disclosure, and such exemplifications are not to be construed as limiting the scope of the invention in any manner.

### DETAILED DESCRIPTION

Briefly, energy is reserved in a battery and is made available to a load after receipt of a reserve enable signal. Energy is reserved by reserve logic operable to disconnect the load or disable current flow to the load when the battery voltage reaches a low level. The low level is determined based on the amount of reserve energy required by the load to perform its function. The low level is set above a minimum level, which may represent a discharge level at which further current draw will damage the battery. The energy corresponding to the difference between the low voltage and the minimum voltage is the reserve energy. A user can cause the reserve energy to be made available by the reserve logic by, for example, providing the reserve enable signal with a switch. The reserve energy is then made available to the load. For example, if the function of the load is to start an engine, the low voltage is set such that the reserve energy is enough to start the engine.

Among other advantages, the above-mentioned and other disclosed features which characterize the embodiments of the apparatus and method described herein advantageously prevent deep discharge of the battery and hold energy in reserve to overcome unintended discharging of the battery.

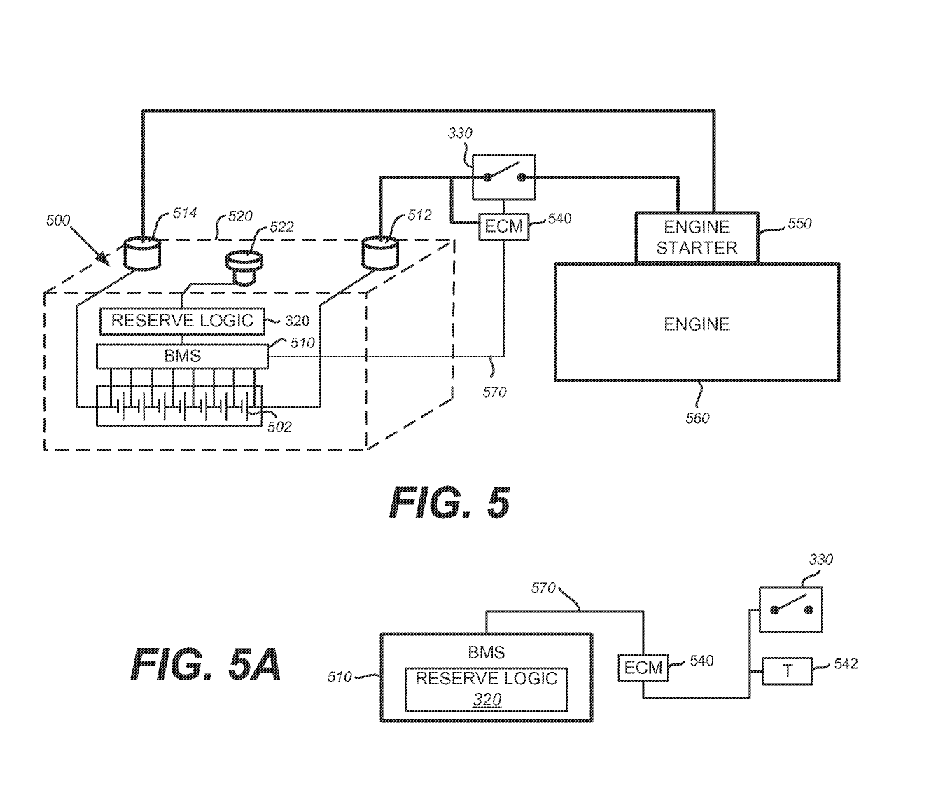

In one embodiment, the load comprises an electrical starter of a combustion engine. The electrical starter consumes electrical power to turn over the engine's crankshaft until combustion begins. Several crankshaft rotations may be required for combustion to begin. Thus, the function of such a load is to cause the crankshaft to rotate until the combustion engine starts, so the low voltage is based on the amount of energy (power over time) needed to start the engine. Since the amount of energy may be temperature dependent, the low voltage may also be temperature dependent. The vehicle includes a temperature sensor. In one example, the temperature sensed by the temperature sensor is received by the reserve logic and used to determine the low voltage. In another example, the reserve logic receives a low voltage indication corresponding to the sensed temperature. The temperature and/or the low voltage indication may be provided by a battery management system or an engine control module (ECM) of an engine control system. In one example, the low voltage is set to provide three cold cranks of the engine. Engines may power vehicles, machinery or a facility such as a factory, an office building or a home. A battery powering an engine is described with reference to FIG. 5.

In one variation, the combustion engine is part of a vehicle. The reserve logic prevents complete battery discharge, which may result from unintentionally leaving lights or a radio on, and allows the user to start the vehicle using the reserved energy without requiring additional power sources. The reserve energy is intended to be used for engine cranking but can also be used to power other electrical devices. After the vehicle starts, a generator (e.g. an alternator) recharges the battery.

In one variation, a reserve enable switch is a push button and is located on the battery. The reserve logic may be included in a battery management system (BMS) or in a standalone apparatus that controls batteries without a built-in BMS. In another variation, the reserve enable signal comprises an ignition switch sequence. A user may, for example, turn the ignition switch on and off three times to indicate the intention to access the reserve energy in the battery. A battery powering an engine is described with reference to FIG. 5.

One or more other technical advantages may be readily apparent to those skilled in the art from the figures, descriptions, and claims included herein. Moreover, while specific advantages have been enumerated above, various embodiments may include all, some or none of the enumerated advantages.

Reference will now be made to the embodiments illustrated in the drawings, which are described below. The foregoing examples and embodiments, and those disclosed below, are not intended to be exhaustive or limit the claims to the precise form disclosed in the following detailed description. Rather, the embodiments are chosen and described so that others skilled in the art may utilize their teachings. Further, the transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

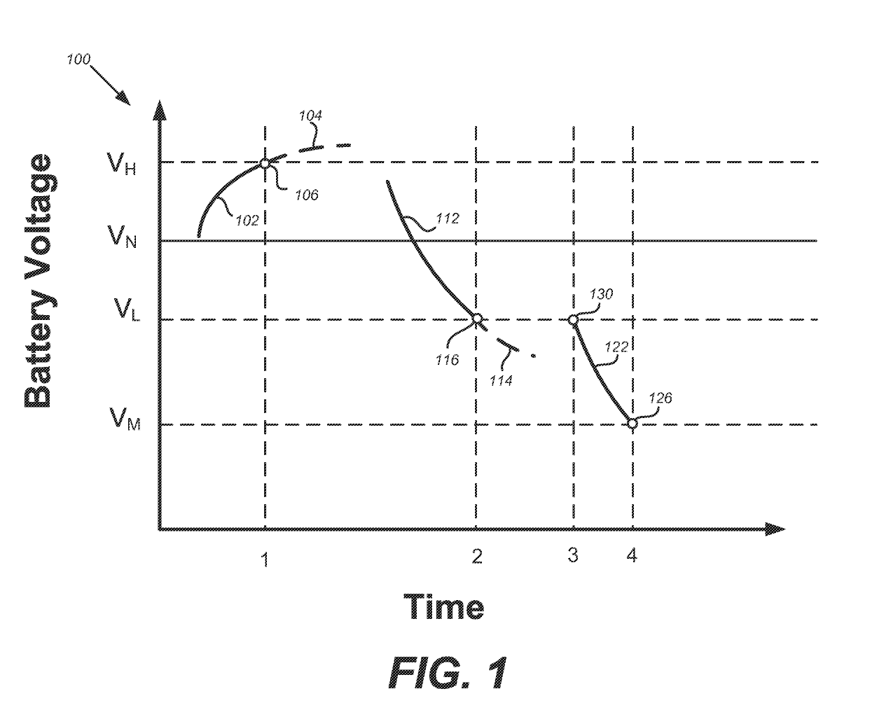

FIG. 1 is a graph 100 representing battery voltage curves relative to time, which illustrates a function performed by an embodiment of a system including reserve logic. The first curve includes segments 102 and 104, which intersect at point 106 corresponding to a high voltage reached at a time 1. Segment 102 represents the voltage of the battery as the battery is charged. Once the battery voltage reaches point 106, charging is disabled. Segment 104 is dashed to represent what the battery voltage would be without overcharge protection.

The second curve includes segments 112 and 114, which intersect at point 116 corresponding to a low voltage reached at a time 2. Segment 112 represents the voltage of the battery as the battery is discharged. Once the battery voltage reaches point 116, discharging is disabled. Segment 114 is dashed to represent what the battery voltage would be without discharge protection.

The third curve includes segment 122, which intersects the minimum voltage at a point 126 corresponding to a time 4. Segment 122 represents the voltage of the battery as the battery is discharged beyond the low voltage, after a user commands the reserve logic, at a time 3 corresponding to a point 130, to enable discharge to make the reserve charge available to the load. Discharging is disabled again once the battery voltage reaches the minimum voltage.

The term “logic” or “control logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed.

The terms “circuit” and “circuitry” refer generally to hardwired logic that may be implemented using various discrete components such as, but not limited to, diodes, bipolar junction transistors, field effect transistors, relays, solid-state relays, contactors, triacs, and other logic and power switches. Some of the circuits may be implemented on an integrated circuit using any of various technologies as appropriate, such as, but not limited to CMOS, NMOS and PMOS. A “logic cell” may contain various circuitry or circuits.

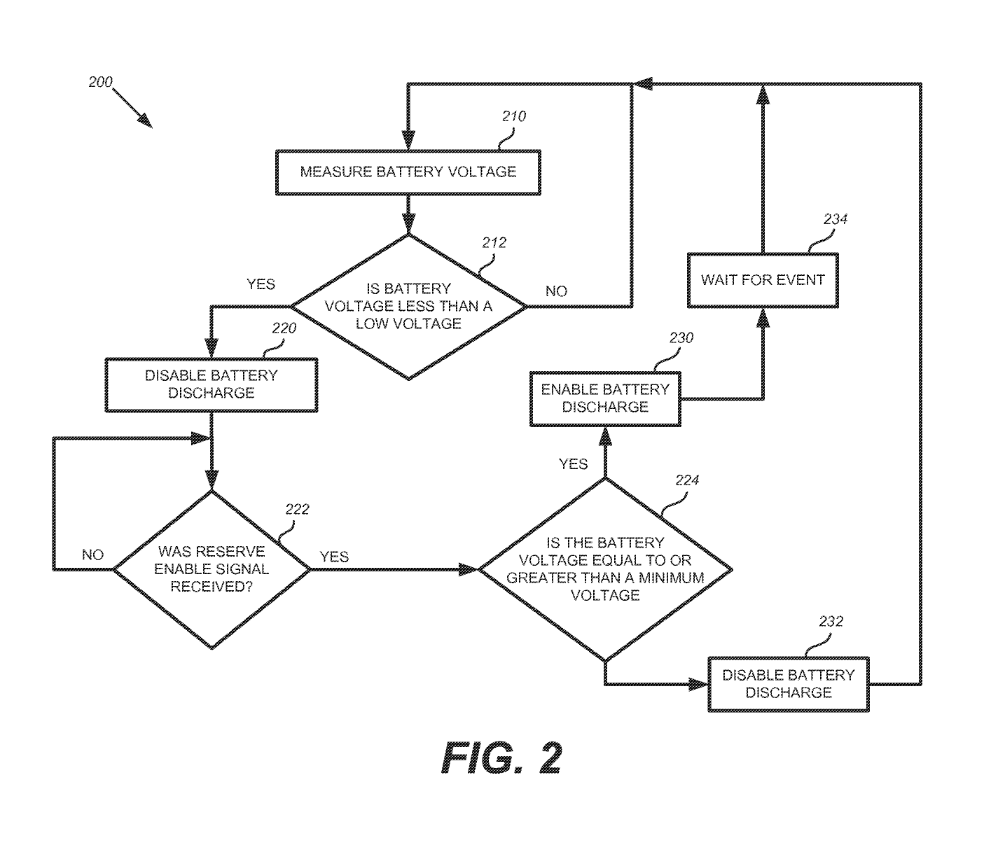

FIG. 2 is a flowchart 200 of an embodiment of a method performed by the reserve logic. The method begins at 210, by measuring the voltage of the battery. The voltage may be measured periodically at intervals sufficiently short to prevent inhibiting performance of the function of the load. In other words, if the function of the load requires a charge corresponding to 10 volts, the minimum voltage should be set to provide more than 10 volts of reserve, so that if the battery voltage is above the minimum voltage in one measurement cycle and below the minimum voltage in the following cycle, the voltage at the following cycle will still be above the reserve. The periodicity of the measurements, and the low voltage, may be empirically determined or may based on typical discharge timing curves for particular or general loads.

The method continues at 212, by determining if the battery voltage is below the low voltage. The reserve logic continues measuring the battery voltage.

If the battery voltage is below the low voltage, the reserve logic disables battery discharge, at 220. Battery discharge may be disabled in different ways. The reserve logic may transmit a discharge control signal or instruction to disable battery discharge. In one variation, the load is disabled by inhibiting current flow to the load in the power circuit. The power circuit includes a power switch that enables or inhibits current flow to the load by closing or opening a power path therethrough. In one example, the discharge control signal deactivates the power switch to prevent current flow to the load. Exemplary power switches include relays, solid state relays, contactors, triacs, silicon controlled rectifiers, and any other device operable to open a power circuit. In a contactor, the power path comprises a contact. The contactor disconnects power by opening the contact. A solid state switch inhibits current flow via internal logic, which comprises the power path. As used herein, power switches may also comprise control logic operable to receive a control logic signal, which may be analog or digital, and to control current flow through the power switch based on the control logic signal. In another variation, current flow is inhibited by load control logic. For example, current flow may be enabled by a discharge control instruction sent from the reserve logic to a load control processor. The discharge control instruction may override a “load on” instruction to cause the load to turn off.

The method continues at 222, by determining whether the user sent a reserve enable signal. If the user did not send the reserve enable signal, the reserve logic continues checking for it.

If the user did send the reserve enable signal, the method optionally continues at 224, by determining whether the battery voltage is equal to or greater than the minimum voltage. In one variation, the reserve logic assumes that the battery voltage is equal to or greater than the minimum voltage, because discharging has been disabled.

If the battery voltage is equal to or greater than the minimum voltage, the method continues at 230, by enabling battery discharge. The load can then perform its function with the reserve charge. The battery may be said to be in a reserve operating mode or reserve state, in contrast with the normal operating mode or normal state, in which the battery voltage is above the low voltage. As discussed above, the reserve logic may transmit the discharge control signal or instruction to disable battery discharge. In one example, the reserve logic disables the transmission to enable battery discharge. In another example, the reserve logic transmits an enable battery discharge signal or instruction to enable current flow to the load.

After enabling battery discharge, the method continues at 234, by waiting for an event. After the event, the reserve logic continues measuring the battery voltage, at 210. An event is a mechanism to limit the duration of the reserve operating mode. Exemplary events include cranking the engine and passage of a predetermined amount of time. For example, in the case of a vehicle, the driver may crank the engine without a successful start. Rather than allowing the cause of the battery drainage, which may still persist, to continue draining the battery, after the unsuccessful start attempt the battery exits the reserve operating mode. The driver can press a button again to send the reserve enable signal and return to the reserve operating mode.

On the other hand, if the battery voltage at 224 is less than the minimum voltage, the method continues at 232, by disabling battery discharge until the battery is recharged. The battery may be said to be in a deep discharge state. After disabling battery discharge, the reserve logic continues measuring the battery voltage, at 210, and the entire cycle repeats.

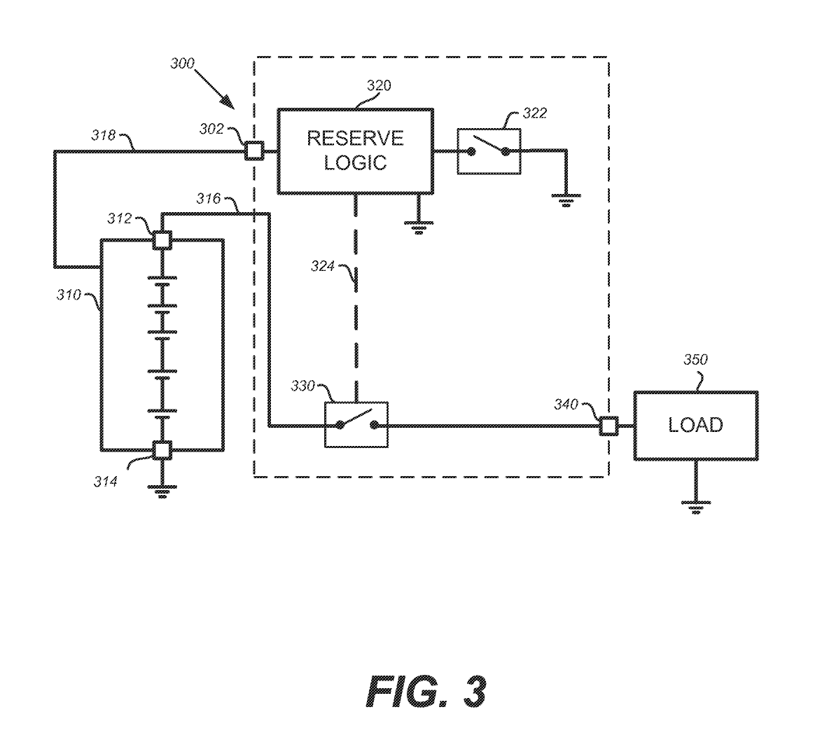

FIG. 3 is a block diagram of an embodiment of a reserve apparatus 300 operable to control current flow to the load with a power switch 330. In one example, reserve apparatus 300 is added to a power system between an existing battery and the load. Reserve apparatus 300 is electrically coupled to a battery 310 and to a load 350. Reserve apparatus 300 includes power switch 330, which is operable to disable current flow to load 350 based on a discharge control signal 324, which may be analog or digital, sent by reserve logic 320. Discharge control signal 324 enables current flow to the load, if the battery voltage is below the low voltage, when reserve logic 320 receives a reserve enable command from a user based on the user's activation of a reserve enable switch 322. Battery 310 includes positive and negative terminals 312 and 314. A power conductor 316 supplies power to power switch 330. Reserve logic 320 determines the voltage of battery 310 via a line 318. In one example, line 318 communicates the analog voltage of battery 310. In another example, battery 310 includes a voltage sensor known in the art and line 318 communicates voltage data output by the voltage sensor corresponding to the analog voltage. Reserve apparatus 300 may include a power terminal 340 to which load 350 may be electrically coupled to receive power from battery 310.

Reserve enable switch 322 may comprise any switch capable of communicating a user's intention to use reserve energy. In one variation, the reserve energy switch is a push button, which may be located on the battery unit or in the engine compartment of a car, for example. In another variation, the reserve enable switch comprises a dual-purpose existing switch. For example, the ignition switch in a car can be used to sense a sequence of switch states indicative of the user's intention to use reserve energy in addition to the intention to start the engine. In another example, a vehicle's gas or propulsion pedal can be sensed in the same manner. In vehicles configured to stop the engine at stop lights to reduce carbon emissions, pressing the gas pedal would indicate to the engine control system that the user intends to start the engine, which signal would also indicate the driver's intention to use reserve energy, if necessary.

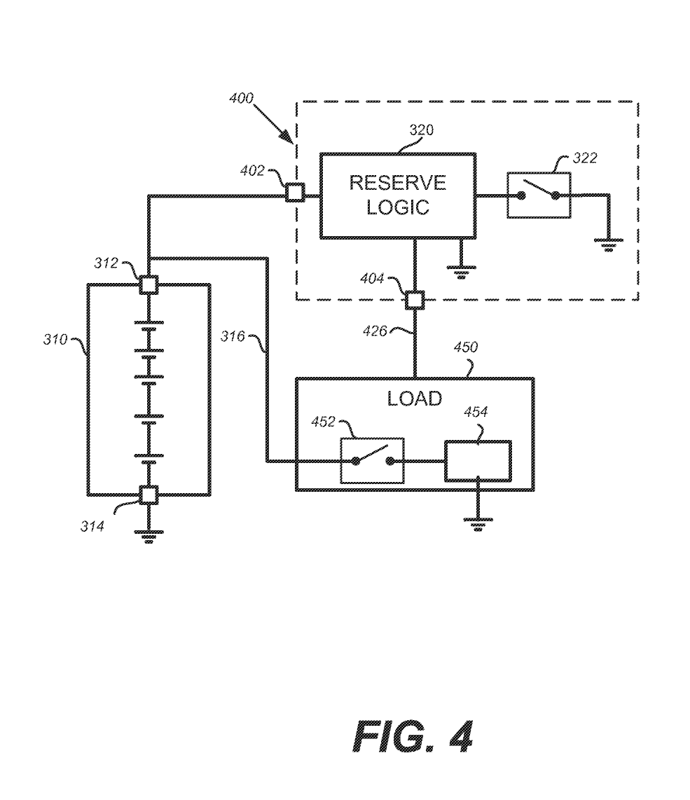

FIG. 4 is a block diagram of another embodiment of a reserve apparatus 400. Reserve apparatus 400 is similar to reserve apparatus 300 except that it relies on a load power switch rather than including a power switch. Reserve apparatus 400 includes a battery voltage contact 402 and a discharge control signal contact 404. Reserve apparatus 400 may sense the battery voltage at battery voltage contact 402. Alternatively, battery voltage contact 402 may be coupled to a communications buss (not shown, e.g. a standard vehicle communications buss) that transmits the battery voltage to reserve logic 320. Reserve apparatus 400 is operable to control current potentially drawn by load 450 with a discharge control signal 426 output through discharge control signal contact 404. Alternatively, discharge control signal contact 404 may be coupled to a communications buss that transmits discharge control signal 426 to load 450. Load 450 includes a power switch 452 and a power consumer 454. Load 450 may also include control logic (not shown) operable to activate power switch 452 based on load control signal 426. Alternatively, load control signal 426 may control power switch 452 directly. Load control signal 426 controls current flow to power consumer 454 in the manner described above with reference to FIGS. 3 and 4. Reserve apparatus 400 may be integrated in a battery management system.

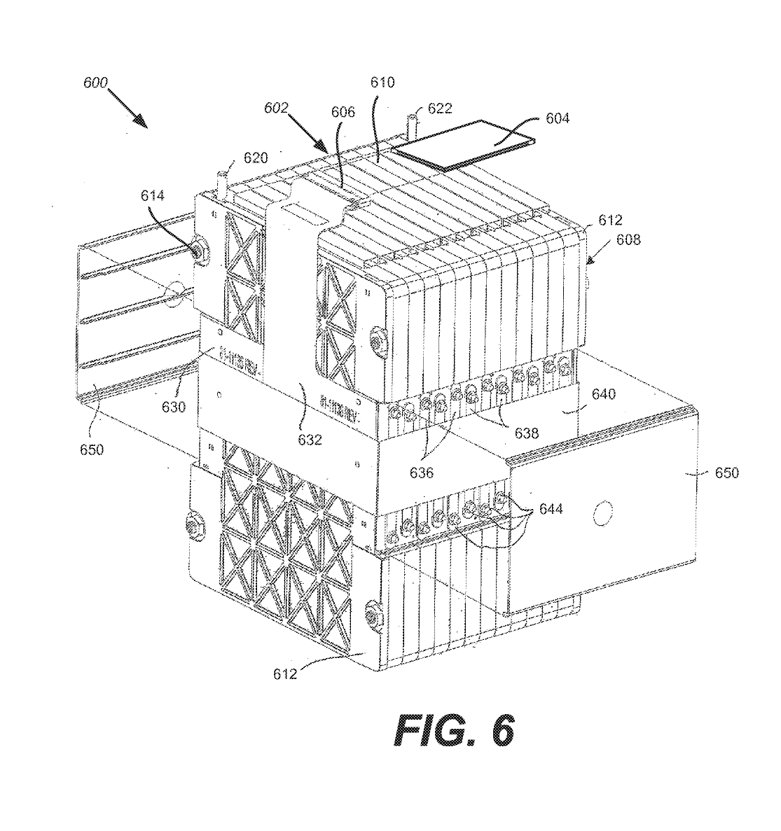

FIG. 5. is a schematic diagram of another embodiment of a battery powering a load. A battery unit 500 is shown including a battery stack comprising multiple battery cells 502. An exemplary battery stack is discussed with reference to FIG. 6. In the present embodiment, the load comprises an engine starter 550 coupled to an engine 560. Exemplary battery cells include lithium-ion cells. Battery cells 502 are coupled to BMS 510 by multiple switches (not shown) as known in the art. BMS 510 activates the switches to isolate each battery cell 502 in order to measure its voltage. BMS 510 may also perform a cell balancing function by selectively charging or discharging individual battery cells 502 to equalize their voltages. BMS 510 measures the battery voltage (e.g. the stack voltage) and communicates the battery voltage to reserve logic 320. In one variation, BMS 510 communicates a signal indicating that the battery voltage is above or below the low voltage and above or below the minimum voltage. In a further embodiment, reserve logic 320 is integrated with BMS 510, as shown on FIG. 5B. Due to its integral battery management system and reserve logic, battery unit 500 may be a suitable replacement for lead-acid batteries.

The battery is connected to, respectively, positive and negative battery posts 512 and 514, which are supported by a battery unit frame 520. A reserve enable switch, illustratively a push button 522, is also supported by battery unit frame 520 and is coupled to reserve logic 320. Power switch 330 is shown between positive battery post 512 and engine starter 550. As discussed with reference to FIG. 3, power switch 330 is controlled by reserve logic 320 to enable or inhibit current flow to engine starter 550.

Of course, the battery may, and typically does, power other devices. The vehicle may include a battery management system. An ECM module 540 is shown, powered by the battery even if the battery voltage is below the low voltage since it is coupled to the supply side, and not the load side, of power switch 330. Reserve logic 320 may communicate with ECM 540 via a communications buss 570. Referring to FIGS. 5 and 5A, in one example ECM 540 controls power switch 330 responsive to a signal from reserve logic 320 received over communications buss 570. ECM 540 also receives an engine temperature indication from a temperature sensor 330 and may communicate the temperature indication to BMS 510, which in the present example includes reserve logic 320 and may be referred to as a BMS module. An exemplary BMS module coupled to a battery unit with an edge connector is shown in FIG. 6. As described with reference to FIG. 2, reserve logic 320 disables battery discharge if the battery voltage is less than a low voltage, inhibiting current flow from the battery to engine starter 550. When push button 522 is pushed, the reserve enable signal is transmitted to reserve logic 320 which, in turn causes the battery to enter the reserve operating mode, enabling a driver to crank engine starter 550 to start engine 560.

The power required to crank the engine at different temperatures may be stored in non-transitory memory. The reserve logic may determine the low voltage based on a relationship between the engine temperature and the battery voltage. The engine low temperature may be predicted by extrapolating historical information, such as the average lowest temperatures over the previous three days, which the ECM measures and records. In this manner, the reserve logic reserves more or less energy depending on the expected engine temperature and the corresponding cold cranking power requirement.

In one example, the reserve enable signal comprises an ignition switch sequence. The user may turn the ignition switch on and off several times to indicate to the reserve logic that reserve energy should be made available. The ignition switch may be coupled to the ECM. The BMS may be integrated or communicatively coupled with the ECM and/or the reserve logic, so that the ignition switch signal is communicated to the reserve logic. The ECM may then receive the discharge control signal from the reserve logic and engage the engine starter power switch.

In a further variation, if the engine does not start in the reserve operating mode, the reserve state is cancelled. The user may once again command the reserve logic to make available the reserve energy. Each time the reserve state is cancelled, the reserve logic checks the battery voltage before re-entering the reserve operating mode.

FIG. 6. is a perspective view of an embodiment of a battery unit 600 including a battery module 602 and a BMS and reserve logic module 604. Battery module 602 is described in more detail in commonly owned U.S. patent application Ser. No. 13/508,770, which is incorporated in its entirety herein by reference. BMS and reserve logic module 604 is operable to perform the functions described above, such as monitoring battery cell voltages, storing low voltages and determining whether and when to enter and exit the reserve operating mode. Battery unit 600 is operationally similar to battery unit 500 in that both units include a BMS and reserve logic. BMS and reserve logic module 604 is removably coupled to battery module 602 with an edge connector 606.

Battery module 602 includes a sub assembly module 608 comprising multiple parallel cell assemblies 610 disposed between end plates 612. Four threaded rods 614 tightly secure cell assemblies 610 between end plates 612. Cell assemblies 610 may be electrically coupled in series, in parallel, or both in series and parallel. Power is output through battery terminals 620 and 622. Battery module 602 further comprises a non-terminal side flex circuit 630, a terminal side flex circuit 632, positive cell tab compression bars 636 and negative cell tab compression bars 638 and a tape filament 640 covering compression bars 636 and 638. Compression bars 636 and 638 are secured by washers and nuts 644 and protected by side shields 650.

As discussed previously, certain battery technologies, such as lithium-ion, may become damaged if discharged beyond a minimum voltage. The foregoing disclosure presents a method and an apparatus for preventing over-discharging the battery while at the same time permitting a user to rely on reserve energy to supply power to the load when the battery voltage is low. The above detailed description of the invention and the examples described therein have been presented only for the purposes of illustration and description. It is therefore contemplated that the present invention cover any and all modifications, variations or equivalents that fall within the spirit and scope of the basic underlying principles disclosed above and claimed herein.

What is claimed is:

1. A method for controlling a battery to power a load, the method comprising:
disabling battery discharge if a battery voltage is less than a low voltage, wherein disabling battery discharge inhibits current flow from the battery to the load;
receiving a reserve enable signal; and
enabling battery discharge after receipt of the reserve enable signal even if the battery voltage is less than the low voltage.

2. A method as in claim 1, wherein the load comprises an engine starter of an engine, and enabling battery discharge after receipt of the reserve enable signal comprises enabling current flow to the engine starter sufficient to start the engine.

3. A method as in claim 2, wherein the reserve enable signal comprises an ignition switch sequence.

4. A method as in claim 1, wherein enabling battery discharge comprises closing a power path to enable current flow from the battery to the load.

5. A method as in claim 1, further comprising, by a reserve logic, transmitting a discharge control signal to a power switch after receiving the reserve enable signal from a user to enable current flow to the load.

6. A method as in claim 1, wherein the reserve enable signal corresponds to a state change of a reserve enable switch.

7. A method as in claim 1, further comprising disabling battery discharge when the battery voltage is equal to or less than a minimum voltage, the minimum voltage being less than the low voltage.

8. An apparatus to implement a method for controlling a battery to power a load, the apparatus comprising:
a voltage contact operable to receive a battery signal corresponding to a battery voltage;
an output contact operable communicate a discharge control signal; and
reserve logic coupled to the voltage contact and the output contact, the reserve logic configured to:
disable battery discharge if the battery voltage is less than a low voltage, wherein disabling battery discharge inhibits current flow from the battery to the load;
receive a reserve enable signal; and
enable battery discharge after receipt of the reserve enable signal even if the battery voltage is less than the low voltage.

9. An apparatus as in claim 8, further comprising an engine having an engine starter, wherein the load comprises the engine starter, and enabling battery discharge after receipt of the reserve enable signal enables current flow to the engine starter sufficient to start the engine.

10. An apparatus as in claim 9, wherein the reserve enable signal comprises an ignition switch sequence, further comprising transmitting the discharge enable signal after receiving the ignition switch sequence.

11. An apparatus as in claim 8, further comprising an battery management system comprising the reserve logic, wherein the load comprises an engine having an engine starter, and enabling battery discharge after receipt of the reserve enable signal enables current flow to the engine starter sufficient to start the engine.

12. An apparatus as in claim 8, wherein enabling battery discharge comprises closing a power path to enable current flow from the battery to the load.

13. An apparatus as in claim 8, wherein the reserve logic is operable to transmit the discharge control signal to a power switch after receiving the reserve enable signal from a user to enable current flow from the battery to the load.

14. An apparatus as in claim 8, further comprising a reserve enable switch, wherein the reserve enable signal corresponds to a state change of the reserve enable switch.

15. An apparatus as in claim 8, wherein the reserve logic is operable to disable battery discharge when the battery voltage is equal to or less than a minimum voltage, the minimum voltage being less than the low voltage.

16. An apparatus as in claim 8, wherein the apparatus is integrated with a battery.

17. An integrated circuit operable to control a battery to power a load, the integrated circuit comprising reserve logic configured for:
disabling battery discharge if a battery voltage is less than a low voltage, wherein disabling battery discharge inhibits current flow from the battery to the load;
receiving a reserve enable signal; and
enabling battery discharge after receipt of the reserve enable signal even if the battery voltage is less than the low voltage.

18. An integrated circuit as in claim 17, wherein the load comprises an engine starter of an engine, and enabling battery discharge after receipt of the reserve enable signal comprises outputting a discharge control signal configured to enable current flow to the engine starter sufficient to start the engine.

19. An integrated circuit as in claim 18, wherein the reserve enable signal comprises an ignition switch sequence.

20. An integrated circuit as in claim 18, wherein the reserve logic is operable to disable battery discharge when the battery voltage is equal to or less than a minimum voltage, the minimum voltage being less than the low voltage.

21. A non-transitory computer readable medium comprising processing instructions embedded therein which when executed by a processor cause the processor to implement a method for controlling a battery to power a load, the method including:
disabling battery discharge if a battery voltage is less than a low voltage, wherein disabling battery discharge inhibits current flow from the battery to the load;
receiving a reserve enable signal; and
enabling battery discharge after receipt of the reserve enable signal even if the battery voltage is less than the low voltage.
